(19) United States
(12) Patent Application Publication
(10) Pub. No.: US 2008/0253436 A1
(43) Pub. Date: Oct. 16, 2008

(54) Method and System for Measuring the Occupation and Allocation of a Transmission Spectrum

(75) Inventor: Martial Bellec, Dinan (FR)

Correspondence Address: MCKENNA LONG & ALDRIDGE LLP, 1900 K STREET, NW, WASHINGTON, DC, 20006, US

(73) Assignee: France Telecom, Paris (FR)

(21) Appl. No.: 12/084,579

(22) PCT Filed: Nov. 7, 2006
(86) PCT No.: PCT/FR2006/002482

§ 371 Date: Jun. 13, 2008

(30) Foreign Application Priority Data
Nov. 7, 2005 (FR) 0511304

(51) Int. Cl. H04B 17/00

(52) U.S. Cl. 375/224

(57) ABSTRACT

The invention relates to a method for measuring the occupancy of at least one transmission spectrum for a multicarrier radiofrequency signal communication system, wherein the method comprises slicing the spectrum into subsets of carriers and of time slicing within the subsets to form elementary time/frequency segments, signal non-transmission, by at least one transmission equipment item of the system, during elementary non-transmission segments mutually shifted over time and in frequency, and measuring chosen parameters of signals conveyed in the transmission spectrum during each of these elementary non-transmission segments.

The present invention relates to the measurement of occupancy and the allocation of at least one transmission spectrum for a multicarrier signal communication system. Occupancy is understood to mean the presence of at least one signal on a part of the spectrum.

This type of system such as WRAN or other mobile telephone systems, uses transmissions termed OFDM or OFDMA (“orthogonal frequency division multiplexing” and “orthogonal frequency division multiplexing access”), applied to a signal or to several signals.

The signals conveyed on the networks of these systems consist of temporal symbols, each being transmitted on a set of carriers at different frequencies.

These systems are conventionally dynamic systems whose transmission equipment can connect or disconnect. This is the case for the OFDM systems or else for the OFDMA systems for a local radio loop such as WRAN in which transmitters can interrupt or resume their transmissions without the other transmitters being advised thereof.

Conventionally, the transmission equipment items form systems within which they are grouped and, within each group a particular equipment item, termed the base station, determines the allocation of the transmission spectrum for this group. The various systems may be ignorant of or aware of the others but without taking them into account at the allocation level. On the other hand, the transmission equipment items of one and the same system are adapted so as not to interfere with one another.

Measurement of the occupancy of the transmission spectrum is important for allowing optimization of the allocation between the transmission equipment items.

In particular, in current systems, priority parameters are allocated, so that certain subsets of carriers are normally reserved for equipment items or dynamically allocated so as to comply with quality of service QoS requirements. In particular, different priorities can be allocated to neighboring systems.

In these systems, measurements of spectral occupancy are necessary so that the spectrum is allocated while taking account of the priority equipment items. In particular, these measurements must be carried out on an RF space common to the systems, that is to say on a frequency band on which the reception equipment items are capable of receiving signals transmitted by transmission equipment items of various systems. If the priority parameters are not complied with, the quality of the corresponding services can no longer be ensured.

By extension, in the case of mobile telephone systems, such as third-generation systems termed 3GPP LTE (“Long Term Evolution”), the base stations are the system's relays to which the telephone equipment items which are at one and the same time transmitters and receivers connect.

In these systems there are no priority parameters. However, to maintain the quality of service, it is necessary to update the parameters regarding the quality of the radio link and its environment when the mobile terminal moves. This is the case in particular for a mobile telephone passing from one relay to another while a communication is already established and has to be maintained (so-called “handover” situation). On the basis of the measurements, typically of radio levels of the other cells performed and uploaded to the base station by the mobile terminal, the handover between cells and the associated spectrum allocation can be carried out.

In all cases, the variability of the bit rates used during the connections, in particular multimedia and Internet, and the proximity of the carriers demand a better allocation than static reservation. In particular, static allocation is not appropriate for RF spaces common with heterogeneous traffic sharing the same frequency bands and which comprise priority equipment items on certain subsets of carriers and other equipment items to which no priority parameter is attached as in a WRAN system.

It is then desirable to carry out dynamic allocation of the spectrum of the common RF space, the reserved subsets being redistributed when they are not used.

A problem crops up when, once the communication has been established by a non-priority equipment item on a reserved subset of carriers, an equipment item having a higher priority level suddenly uses the same spectrum portion, thus compelling the non-priority terminal to release the spectrum portion coveted by the priority terminal. In this case, the non-priority equipment item must be able to detect this event and, thereafter, to release the spectrum used, thus ceasing to interfere with the priority equipment item.

It should be noted that each transmission equipment item has its own transmission spectrum commonly called main channel. Problems of interference between two transmission equipment items can arise on the transmission spectrum of an equipment item but also on other parts of the spectrum of the common RF space. Specifically, it is possible to consider that, rejections of the transmitters not being ideal on the adjacent channels, also termed secondary channels, the transmission in the main channel results in the undesired generation of interference on the secondary channels. In this sense, the spectrum portion to be taken into account can comprise, not only the main channel, but also the secondary channels.

Dynamic allocation such as this requires fine management of the occupancy of the transmission spectrum. Although there are already techniques implemented in this field, none is satisfactory.

For example, patent document WO 2005/069522 performs detections and measurements in particular of the signal-to-noise ratio and therefore, of the occupancy over the whole of the spectrum, so that it is not possible to distinguish the subsets of carriers and in particular, the reserved subsets.

The aim of the present invention is to solve this problem by defining a method for measuring the occupancy of the spectrum allowing fine measurement, in view in particular, of an optimized allocation of the spectrum while maintaining a quality of service. The invention also relates to corresponding computer programs, a system and equipment items as well as to the signal conveyed.

For this purpose, the subject of the invention is a method for measuring the occupancy of at least one transmission spectrum for a multicarrier radiofrequency signal communication system, characterized in that the method comprises:
a step of slicing the spectrum into subsets of carriers and of time slicing within the subsets to form elementary time/frequency segments;
a step of signal non-transmission, by at least one transmission equipment item of the system, during elementary non-transmission segments mutually shifted over time and in frequency; and
a step of measuring chosen parameters of signals conveyed in the transmission spectrum during each of these elementary non-transmission segments.

By virtue of this method and, in particular, of the determination of elementary signal non-transmission segments and of the measurement of parameters of the signals transmitted on these segments, it is possible to detect the emergence of transmissions due to other equipment items on a particular subset of carriers and in particular, the emergence of transmissions on a reserved subset.

According to other characteristics of the invention:
the system comprises a plurality of transmission equipment items each carrying out a step of slicing the transmission spectrum, a step of non-transmission during elementary non-transmission segments and a step of measuring parameters;
said system comprises a plurality of groups of transmission equipment items, the slicing, non-transmission and measurement steps being carried out in a coordinated manner for the whole group;
said system comprises a plurality of groups of transmission equipment items and in that, a single slicing step is carried out for at least one group, so that none of the equipment items of this group transmits during the elementary non-transmission segments;
characteristics of frequency and/or of duration of the elementary segments are determined as a function of characteristics of the operating environment;
said elementary non-transmission segments are distributed in time over a determined period and in frequency over the whole of the transmission spectrum to form a non-transmission pattern;
said elementary non-transmission segments are distributed so as to form the non-transmission pattern as a function of characteristics of the operating environment;
the slicing step as well as the non-transmission and measurement steps are repeated several times for one and the same transmission spectrum, so as to form several non-transmission patterns, the slicing step comprising the inter-combining of the various patterns;
at least two steps of measurement on distinct elementary non-transmission segments are carried out simultaneously;
said steps of non-transmission and measurement on an elementary segment are repeated without allocating any non-transmission segment in segments reserved for particular equipment items.

According to yet other characteristics of the method of the invention:
the elementary non-transmission segments are distributed in a regular manner in time and over the transmission spectrum;
various patterns of elementary non-transmission segments are juxtaposed with one another during said combining step;
various patterns of elementary non-transmission segments are mutually superimposed during said combining step;
for at least one non-transmission pattern, the elementary non-transmission segments are simultaneous;
the measured parameters comprise at least one parameter from among the group formed: of a priority level of assignment of a determined subset, of an energy level on a part of the transmission spectrum, of temporal characteristics, of coding characteristics, or of transmitter and/or recipient characteristics;
said step of measuring parameters comprises a sampling of the signals conveyed during the elementary non-transmission segments and the determination of parameters as a function of these samples in real time in the course of each of the elementary non-transmission segments;
said step of measuring parameters comprises a sampling of the signals conveyed during the elementary non-transmission segments and the determination of parameters as a function of these samples on completion of the sampling and before a new step of measurement on an elementary non-transmission segment of the same subset of carriers;
said steps of non-transmission and measurement on an elementary non-transmission segment are repeated periodically;
at least one non-transmission step comprises the transmission of at least one substantially zero signal on all or some of the carriers of the corresponding elementary non-transmission segment; and
at least one non-transmission step comprises the rejection of the radiofrequency signal on all the carriers of the corresponding elementary non-transmission segment.

The invention also relates to a method for allocating the spectrum of a multicarrier signal of a communication system, characterized in that it comprises the measurement of the occupancy of the spectrum according to the method previously described as well as a step of allocating the spectrum between transmission equipment items of the system as a function of said measurements.

The subject of the invention is also a computer program for an equipment item of a multicarrier radiofrequency signal communication system, characterized in that it comprises instructions which, when they are executed on a computer of this equipment item, control the implementation of the method previously described.

Additionally the invention relates to an equipment item for a multicarrier radiofrequency signal communication system, characterized in that it comprises means for slicing at least one transmission spectrum into subsets of carriers and for time slicing within the subsets to form elementary time/frequency segments and means for signal non-transmission during elementary non-transmission segments mutually shifted over time and in frequency.

Likewise, the invention pertains to an equipment item for a multicarrier radiofrequency signal communication system, characterized in that it comprises means for receiving a signal comprising elementary time/frequency non-transmission segments during which no signal is transmitted by at least one equipment item of the system and means for measuring chosen parameters of signals conveyed in the transmission spectrum during each of these elementary non-transmission segments.

Finally, the invention pertains to a multicarrier radiofrequency signal comprising elementary data segments corresponding to time periods determined over determined subsets of carriers, characterized in that it comprises elementary non-transmission segments mutually shifted over time and in frequency which do not comprise any data.

Advantageously, this radiofrequency signal furthermore comprises signalling information cues representative of the shifts between the non-transmission segments.

The invention will be better understood in the light of the description given by way of example and with reference to the figures in which:

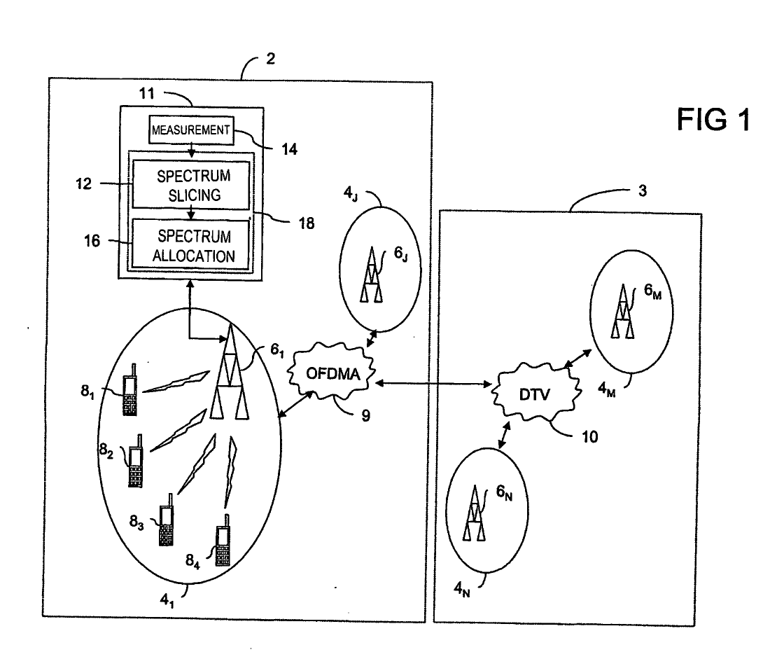

FIG. 1 schematically represents a system implementing the method of the invention;

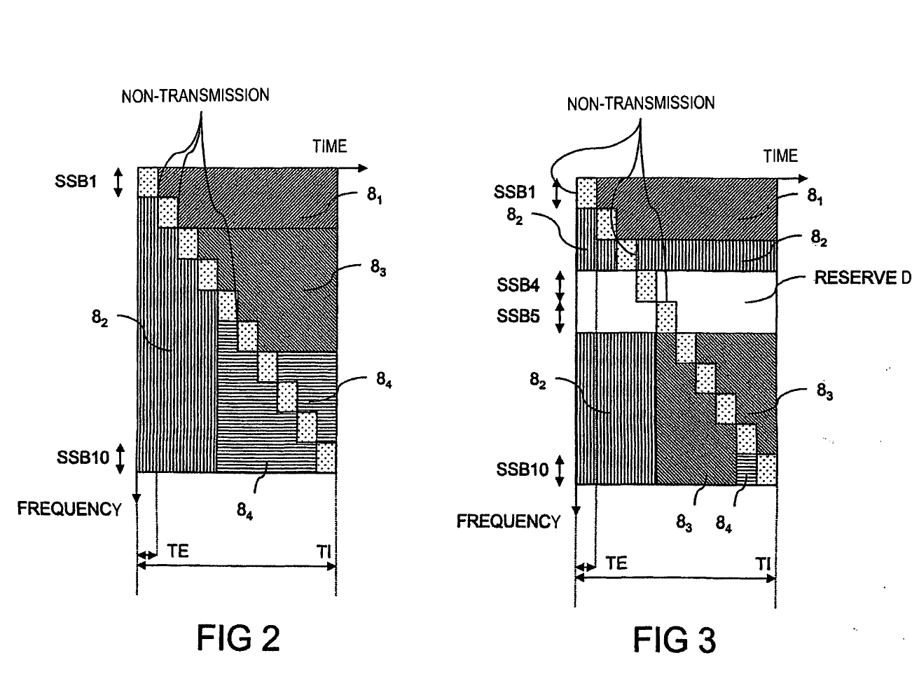

FIGS. 2 and 3 represent the allocating of the transmission spectrum in the system of FIG. 1;

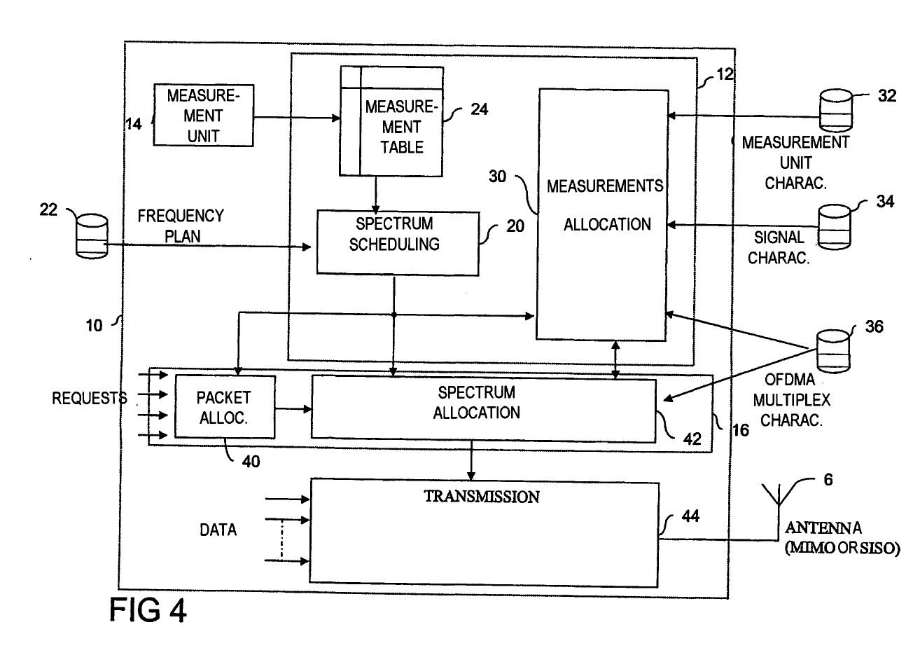

FIG. 4 represents the details of one of the equipment items of the system of FIG. 1; and

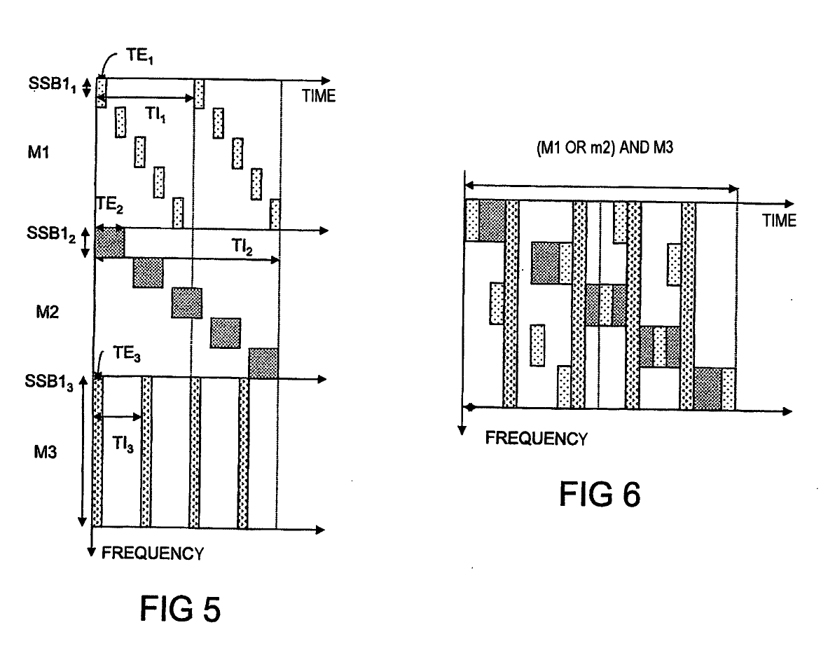

FIGS. 5 and 6 represent the allocating of the transmission spectrum in another embodiment of the invention.

FIG. 1 represents an operating environment implementing the method of the invention and comprising frequency and time multiplexed multicarrier signal communication systems.

In a first embodiment, the invention is described in a communication of broadcast type, that is to say with a fixed transmission equipment item, or base station, addressing signals to reception equipments.

This environment comprises two systems 2 and 3 each comprising groups of equipment items marked 4₁ to 4_{M}. Each group comprises at least one transmission equipment item 6₁ to 6_{M} such as a base station equipped with one or more antennas. With each base station are associated several reception equipment items such as the equipment items 8₁ to 8₄ associated with the base station 6₁. Each reception equipment item of a group is addressed by the corresponding base station in distinct time and frequency segments of the transmission spectrum and the allocation of the transmission spectrum of each equipment item takes into account the other transmission equipment items of the group.

Each system comprises a transport network allowing data exchanges between the groups and between the terminals. In the example, the system 2 comprises a network 9 of OFDMA type and the system 3 comprises a network 10 of DTV (Digital TV) type. These systems exhibit a common RF space, that is to say a frequency band in which signals originating from different systems are capable of being conveyed.

In the example described, for simplicity reasons, the transmission spectrum is described as being identical for all the equipment items of a group. However, it is possible to have several transmission spectra, that is to say several communication bands or channels.

As indicated previously, the system 2 also coexists with the system 3 comprising a group of equipment items marked 4_{N}, with a transmission equipment item 6_{N} such as a base station also equipped with at least one antenna. With this base station 6_{N} are associated several reception equipment items, not represented.

By dint of the configuration of the operating environment, the equipment items 8₁ to 8₄ are also capable of receiving the signals transmitted by the base station 6_{N} in the same transmission spectrum portion as that used by the equipment items of the system 2.

Typically, the system 2 can be a WRAN IEEE802.22 radiobroadcasting system and the group of equipment items 4_{N} belongs to the digital television broadcasting system 3 DTV (“Digital TV”). In consequence of established standards, in such a situation, the group of equipment items 4_{N} of the system 3 uses the UHF spectrum by priority relative to the groups of the system 2.

It should be noted that the systems 2 and 3 do not harmonize their spectral use and that, in this sense, no specific communication is envisaged between them.

By its nature, such an environment with these systems is dynamic and heterogeneous. Specifically, the environment is dynamic in the sense that transmission equipment items can enter into communication or interrupt their communication while sharing the same transmission spectrum or neighboring spectra.

Additionally, the whole set of equipment items is termed heterogeneous since it comprises equipment items for transmission with different priority levels on particular sets of carriers or subsets of carriers. Thus, certain frequency subsets of the transmission spectrum are normally reserved for certain equipment items while other equipment items do not have priority parameters.

The construction and operating environment with the systems 2 and 3 is conventional and will not be described in greater detail.

In the embodiment described, the base station 6₁ comprises a device 11 for allocating the transmission spectrum. This device comprises a unit 12 for slicing the spectrum, a unit 14 for measuring parameters of the signals conveyed in the transmission spectrum and a unit 16 for allocating the transmission spectrum. These various units are, for example, dedicated components or else programs or elements of computer programs. In the embodiment described, the measurement unit 14 is a dedicated equipment item linked by an appropriate data bus to a microprocessor or a microcontroller 18 which comprises a read only memory or a random access memory in which are stored programs forming the units 12 and 16.

The details of the device 11 for allocating the spectrum are described subsequently with reference to FIG. 4.

The general operating principle of the invention will now be explained with reference to FIGS. 1, 2 and 3.

The spectrum slicing unit 12 makes it possible to carry out a slicing of the transmission spectrum into subsets of carriers denoted SSB1 to SSB10 in FIGS. 2 and 3. This unit 12 also makes it possible to slice each subset of carriers in time so as to form elementary time/frequency segments of a determined duration denoted TE.

An allocation of the transmission spectrum is thereafter carried out between the various equipment items of the group 8₁ to 8₄ while preserving in each subset of carriers an unallocated elementary segment, that is to say allocated to none of the equipment items of the group. Consequently, the base station 6₁ will transmit no signal to any of the equipment items of the group during these elementary so-called non-transmission segments. Signal non-transmission is justified by the fact that, by dint of the construction of the transmitter-receiver of the base station, the insulation is insufficient between transmitter and receiver, leading to interference and therefore a bias, or worse still, to saturation or blinding, of the receiver.

FIG. 2 is a representation of a plan for allocating the transmission spectrum obtained. In this figure, time is along the abscissa and frequency along the ordinate. In this example, the subsets of carriers SSB1 to SSB10 are formed in a regular manner over the entire transmission spectrum, that is to say they all comprise the same number of carriers. Likewise, the elementary non-transmission segments of the various subsets are distributed in a regular manner in time and in frequency, that is to say the gaps in time and in frequency between two consecutive elementary segments are constant. The whole set of elementary non-transmission segments is called a non-transmission pattern and is constituted, in the example, of contiguous time frequency portions whose time dimension is an integer multiple of TE and whose dimension in frequency is an integer multiple of SSB.

A complete pattern extends in frequency over the whole of the transmission spectrum of the main channel and in time over a determined duration termed sampling duration TI.

In the case where the transmission spectra are not identical, the pattern can be extended also over k secondary channels, the sampling duration TI would then become k times TI.

As may be seen in FIG. 2, 17 elementary segments are allocated to the equipment item 8₁, 30 to the equipment item 8₂, 22 to the equipment item 8₃ and 21 to the equipment item 8₄. The representation given in FIG. 2 is intentionally simplified by presenting a continuous allocation and not the real allocation, that is to say according to OFDMA technology, with a partition equidistributed over the transmission spectrum so that the carriers intended for the various equipment items are interleaved.

Subsequently, information cues are transmitted to each of the reception equipment items by the base station 6₁ while complying with these slots of the transmission spectrum.

During the elementary non-transmission segments, the measurement unit 14 is implemented so as to detect the emergence of signals conveyed in the transmission spectrum, that is to say of signals transmitted by other transmission equipment items in the common RF space. The unit 14 is adapted for measuring chosen parameters of these signals.

Additionally, during the non-transmission segment, the measurement can equally well be performed in the so-called main channel as in the secondary channels by means, for example, of heterodyne frequency transpositions. As indicated previously, subsequently in the description, we limit ourselves within the framework of this realization to the measurement on the main channel.

In the example, the measurement unit 14 comprises a correlator implemented so as to determine the energy accumulated by the signals conveyed on each of the subsets of carriers during the elementary non-transmission segments. When the energy exceeds a critical threshold, this transmission must be taken into account at the level of the group. Consequently, the unit 14 detects the spectrum portions on which signals above a critical threshold are conveyed.

In an embodiment, the measurement comprises a sampling of the signal and a determination of the parameters done in real time during the non-transmission segment. Alternatively, this measurement comprises a sampling carried out in the course of the elementary segments and the subsequent determination of the measured parameters. This subsequent determination is completed before the arrival of a new non-transmission segment on the same subset of carriers i.e., in the case where the measurements are carried out periodically, for the duration TI-TE.

The use of these elementary non-transmission segments in each of the subsets of carriers thus makes it possible to detect the emergence of signals transmitted by equipment items not referenced in the group and to evaluate the corresponding priority level.

For example, signals originating from the priority equipment item 6_{N} of the group 4_{N} belonging to the system 3 on the subsets of carriers SSB4 and SSB5 are detected.

Consequently, a new allocation in time and in frequency of the transmission spectrum between the various equipment items of the group is carried out as a function of the measurements made previously.

In particular, this allocation takes into account the priority level for assigning the subsets SSB4 and SSB5 so as to culminate in the allocation plan represented with reference to FIG. 3.

In this example, that part of the transmission spectrum allocated to the equipment item 8₄ is reduced so that one and the same amount of the transmission spectrum is allocated to the other equipment items. This makes it possible to maintain the quality of service for the equipment items 8₁ to 8₃ while complying with the priority equipment items.

Thus, in the new allocation plan a single segment is allocated to the equipment item 8₄. Additionally, in this new allocation plan, 20 elementary segments are reserved in the frequency subsets SSB4 and SSB5.

In this embodiment, the same non-transmission pattern is maintained in the two allocation plans, that is to say with the same number of the same elementary non-transmission segments distributed in an identical manner in time and in frequency.

In particular, non-transmission segments, in the course of which measurements will be carried out, are maintained in the reserved subsets of carriers. This makes it possible to detect the end of the occupancy of these subsets so as to advantageously dynamically reallocate the transmission spectrum as soon as possible.

Thus, by virtue of the slicing of the transmission spectrum into time/frequency elementary segments and of the reserving of elementary segments in the subsets of carriers in the course of which none of the equipment items of the group is permitted to transmit, it is possible to carry out a fine measurement of the occupancy of the transmission spectrum.

This measurement thereafter makes it possible to dynamically allocate the transmission spectrum while complying with the quality of service, in particular at the level of compliance with the priorities on certain subsets of carriers.

Advantageously, in the course of the step of slicing the transmission spectrum, characteristics of the operating environment are used to determine the characteristics of frequency and/or of duration of the elementary segments. In particular, the elementary segments are determined as a function of the types of signals capable of being conveyed in the transmission spectrum or else the capabilities of the measurement unit or the characteristics of the OFDM transmission network 9.

For example, the duration TE of an elementary segment is chosen equal to an integer number of times the duration of an OFDM symbol, that is to say the duration required for the transmission of a signal on each of the carriers of the transmission spectrum.

In a similar manner, the subsets of carriers SSB comprise an integer number of carriers, that is to say a subset covers a frequency band equal to an integer number of times the gap between two carriers.

Alternatively, the frequency resolution of the measurement means fixes the number of carriers forming a subset and the speed and the memory necessary for the calculation fixes the duration of a non-transmission segment.

In another variant, the number of carriers forming a subset SSB is chosen to correspond to the number of carriers envisaged for a particular signal capable of being conveyed in the operating spectrum, that is to say to correspond to the bandwidth of a particular signal.

The same characteristics of the operating environment can also be taken into account to determine the non-transmission patterns and particularly, the temporal distribution of the non-transmission segments. In a particular embodiment, the sampling duration TI is determined as a function of signals capable of being conveyed in the transmission spectrum. If the signals evolve quickly, it is appropriate to make measurements at short time intervals and therefore, the duration TI separating two non-transmission segments on one and the same subset of carriers is reduced. Conversely, if the signals are slowly evolving, the duration TI is increased.

Thus, the sampling duration TI is determined not only by the application of Shannon's theorem to the width of the coherence band, that is to say the frequency of evolution determined according to a known model, of a type of signal capable of being conveyed but also by the width of the transmission spectrum for this type of signal.

Advantageously, the sampling duration is dimensioned in such a way that the whole of the band of the signal is measured by spectrum portions SSB more rapidly than the variation of this signal. For example if:

SSB=600 kHz,

TE=5 ms,

Bandwidth=6 MHz,

Coherence band=10 Hz,

Then:

We have 6/(0.6*5)≦1/(10/(2*1000))

And TI<50 ms

In the case where the 15 secondary channels situated on either side of the main channel are also measured, k=2*15+1=31 and TI becomes TI′<31*50 ms=1550 ms.

The characteristics of the segments and patterns can also result from a combination of these embodiments, the number of carriers forming a subset being determined, for example, by dividing the bandwidth of a type of signal capable of being conveyed in the transmission spectrum by the resolution of the measurement unit.

The details of the allocation device 11 according to the invention will now be described with reference to FIG. 4.

The spectrum slicing unit 12 comprises a spectrum scheduling element 20 which receives as input the frequency plans for the equipment items of the system 2 that are assumed known, and the frequency plans for the equipment items with priority of the system 3, when they are known, from a database 22. This element 20 also receives a table 24 summarizing the previous measurements and in particular, the detection, if any, of priority signals. This table 24 is provided by the measurement unit 14.

The scheduling element 20 thus makes it possible to maintain in real time the portions of the spectrum which are available on establishment of non-priority transmissions.

The slicing unit 12 also comprises an element 30 for determining the elementary non-transmission segments, that is to say segments in the course of which the measurements will be carried out.

This element 30 receives as input the measurement unit characteristics provided by a database 32 for each type of signals conveyed by the system 3. These characteristics comprise in particular, according to the degree of a priori knowledge of the system 3, the measurement resolution in frequency SSB, the measurement time TE, the size or area in terms of time and frequency, necessary for the realization of a measurement sample, the maximum time interval between 2 consecutive samples, the number of measurement units available simultaneously in the system as well as information cues on the ability of these units to operate in parallel.

Additionally, the element 30 also receives the characteristics, provided by a database 34, of the signals capable of being conveyed. These characteristics include for example, the central frequency and the number of reserved carriers, the coherence band of the signal, the duration of a frame which determines the duration of the segment as well as the number of samples necessary for detecting a change of level or for averaging temporal variations.

In particular, in order to avoid abrupt changes, it is preferable to temporally average the samples for example with a finite impulse response digital low-pass filter of FIR (“Finite Impulse Response”) type. Typically, the maximum bandwidth of this filter is equal to the coherence band of the signal to be detected. Furthermore, temporal hysteresis mechanisms can be implemented on the measurements so as to avoid incessant outward-return trips, or pumping, in the detection table 24 for particularly pulsatile signals whose coherence band is variable over time.

Finally, the element 30 receives the characteristics of the OFDMA multiplex from a database 36, that is to say for example, the multiplexing time and frequency intervals, the area of the smallest segment that can be allocated, the duration of the frame and the maximum percentage of segments allocated.

The element 30 also receives information cues about the spectrum scheduling 20 so as to ascertain the spectrum portion usable by the non-priority system.

With the aid of these information cues, the element 30 determines the characteristics of frequency and of duration of the elementary non-transmission segments as well as their distribution in frequency and in time. Thus, the element 30 determines the non-transmission pattern.

Additionally, the allocation unit 16 comprises first of all an element 40 for allocating packets which receives as input the service transmission requests, that is to say the requests of transmission to the reception equipment items 8₁ to 8₄ of the group.

The element 40 allocates the transmission spectrum according to the requests and according to the quality of service rules as well as the traffic queues.

In a particular embodiment, these rules are those defined in the IEEE802.11b/g standard and are aimed at maintaining, in order of priority:
a constant bit rate for a service;
   a real-time variation in the bit rate of a service;
a non-real-time variation in the bit rate of the service;
a maximum service effort.

The information cues delivered by the spectrum scheduling element 20, by the element 30 for determining the elementary non-transmission segments and by the element 40, are provided to a spectrum allocation element 42.

This element 42 combines the allocation made by the element 40 with that made by the element 30 in the portions of the spectrum which are available on the establishment of non-priority transmissions such as delivered by the element 20 while complying with the OFDMA multiplex structure delivered by the element 36.

For example, this allocation is made in two stages by successively integrating each of the allocations provided by the elements 30 and 40. In an embodiment, the element 42 favors the allocation made for the non-transmission segments so as to guarantee as first priority the detection of the priority signals. As a variant, the element 42 favors the quality of service for certain equipment items so as not to reduce the number of transmission segments envisaged for particular equipment items. For example, in the reserved subsets of carriers, no non-transmission segment is allocated. Thus, in this embodiment, the allocation is carried out so that the number of elementary segments allocated to particular equipment items is not decreased for the allocation of non-transmission segments.

In such an embodiment, the measurement quality is degraded, in particular, the measurements in certain subsets of carriers are not carried out as often as envisaged by the sampling duration TI.

The allocation plan determined by the element 42 is thereafter transmitted to an OFDM transmission unit 44 which receives as input the service data intended for the reception equipment items of the group and forms the signal to be transmitted on the common RF space, either on a single antenna in SISO (“Single Input Single Output”) mode, or on several antennas in MIMO (“Multiple Input Multiple Output”) mode.

Thus, a multicarrier radiofrequency signal is conveyed on the transmission spectrum of the common RF space, which signal comprises elementary segments corresponding to time periods determined on subsets of carriers, in the course of which no signal is transmitted, these elementary non-transmission segments being shifted over time and shifted in frequency.

In another embodiment, the previously described steps of slicing, non-transmission and measurement are repeated several times for one and the same transmission spectrum, so as to form various non-transmission patterns each comprising elementary segments of different characteristics.

Such an embodiment is particularly apt in the case where various types of signals, such as voice signals carried by wireless microphone systems, video signals or else audio-video signals, are capable of being conveyed simultaneously in the transmission spectrum.

In this case, the repetition of each slicing step culminates in the obtaining of several non-transmission patterns M1 to M3 as represented with reference to FIG. 5.

In this FIG. 5, are envisaged three patterns each comprising non-transmission segments of different characteristics. Each of its patterns is obtained by slicing one and the same transmission spectrum and has its own characteristics, in particular in terms of dimension of the subsets of carriers, of duration TE of the non-transmission segments and of sampling duration TI.

It should be noted that the pattern M3 envisages that the non-transmission segments are simultaneous on all the subsets of carriers, forming a non-transmission segment on the whole of the transmission spectrum. In this case, the measurement is carried out on the whole of the transmission spectrum but the parameters are evaluated by subsets.

For this purpose, the system has several measurement units so as to carry out the measurement simultaneously in all the subsets of carriers.

These patterns, that is to say the whole set of non-transmission segments of which they are constituted, are thereafter combined. In a first case, the non-transmission segments are juxtaposed. This culminates however in the allocating of a significant fraction of the transmission spectrum to the non-transmission segments. In the example represented with reference to FIG. 5, 90 elementary non-transmission segments are necessary with juxtaposed patterns.

In order to decrease the number of segments required, it is possible to multiply up the measurement units. For example, two distinct measurement units simultaneously carry out a measurement in the first two patterns. Consequently, it is possible to superimpose the elementary non-transmission segments determined by these two patterns. The result obtained will thereafter be juxtaposed with the third pattern.

It is appropriate to verify whether the measurement units are able to operate simultaneously. For example, if a pattern is intended to detect the presence of a high-strength signal, it must not be superimposed with a pattern intended to detect the presence of a low-strength signal.

The allocation represented with reference to FIG. 6, in which only 80 elementary non-transmission segments are required, is thus obtained.

Of course, if subsets of carriers are reserved, the allocation will be made accordingly.

Yet other embodiments can also be envisaged.

In a variant, several transmission equipment items each separately carry out a step of slicing the spectrum so as to determine non-transmission segments in the course of which each of these equipment items carries out measurements. Thus, each of these equipment items self-imposes non-transmission segments to make measurements but without necessarily taking into account the other transmission equipment items of which it may possibly be aware. Specifically, even if, typically, in order to carry out the allocation of spectrum between the transmission equipment items, the non-transmission information cue is brought to the knowledge of the base station which could enable the other transmission equipment items of this group to benefit therefrom, the non-transmission patterns are not harmonized between the transmission equipment items. Consequently, a given equipment item measures in the non-transmission segments, not only the other systems, such as the system 3, but also, if there are any, the transmissions of the equipment items of its own group or of its own system, thereby leading to a bias in the measurement carried out.

Advantageously, the slicing, the non-transmission and the measurements are done in a coordinated manner within groups of transmission equipment items. This time, the base station enables all the transmission equipment items of its group to benefit from the information cues about the patterns which it has. Thus, the non-transmission patterns of the various transmission equipment items can be synchronized or identical with one another, this not spoiling the measurement of the transmissions of the other equipment items and therefore minimizing the measurement biases in the other systems.

Preferably, a single slicing is carried out for a group, so that none of the transmission equipment items can transmit during the non-transmission segments. This embodiment is particularly advantageous in a mobile telephone system in which each equipment item is at one and the same time transmitter and receiver. In such an environment, the allocation of the spectrum is made by the relay station or base station, which transmits this allocation to the equipment items of its group by imposing on them a non-transmission pattern or a combination of patterns that is synchronous and common to all.

In the examples described, the elementary non-transmission segments distributed over the various subsets of carriers are all identical in frequency and in duration. As a variant, these segments have variable frequency and duration characteristics but retain an identical area so as to allow a similar measurement on each subset of carriers.

Additionally, the various units forming the system can be distributed differently between the equipment items. In particular, the measurement unit and the allocation unit can be in distinct equipment items. Likewise, several measurement units can be used. Thus, in an embodiment, all or some of the equipment items of the system comprise measurement units which are mutualized. Consequently, these equipment items are adapted for sending the measurements that they perform to a remote allocation unit.

Finally, the parameters measured on the signals conveyed in the transmission spectrum during the non-transmission segments can be any type of appropriate parameters such as for example, a priority level of assignment of a determined subset of carriers, an energy level on a part of the transmission spectrum, temporal characteristics, coding characteristics, or transmitter and/or recipient characteristics. For example, the measured parameters comprise the code for scrambling the signal in CDMA, the identity of the base in GSM, the identity of the pilots in WRAN or other levels and physical characteristics of the signal.

Depending on the embodiments, the non-transmission step comprises the transmission of a zero symbol on all the carriers of the corresponding elementary non-transmission segment or else comprises the rejection of the radiofrequency signal on all the carriers of the corresponding elementary non-transmission segment.

It should be noted that the non-transmission segments can be segments in the course of which no signal is transmitted or else segments in the course of which signals are transmitted under the level of radiofrequency masks. Consequently these signals are considered to be non-essential and are not analyzed. Generally it is considered that the non-transmission segments do not comprise any data. The use of radiofrequency masks is conventional in the field of telecommunications and is generally implemented by spectrum analyzers.

Additionally, in a particular embodiment, the signal transmitted comprises signalling information cues forewarning the receivers of the spacing between the non-transmission segments. These signalling information cues represent the temporal and/or frequency shift between the non-transmission segments. Thus, it is possible to adapt and to upgrade the parameters of the non-transmission segments during a transmission.

1. A method for measuring the occupancy of at least one transmission spectrum for a multicarrier radiofrequency signal communication system, wherein the method comprises:
slicing the spectrum into subsets of carriers and of time slicing within the subsets to form elementary time/frequency segments;
signal non-transmission, by at least one transmission equipment item of the system, during elementary non-transmission segments mutually shifted over time and in frequency; and
measuring chosen parameters of signals conveyed in the transmission spectrum during each of these elementary non-transmission segments.

2. The method as claimed in claim 1, wherein the system comprises a plurality of transmission equipment items each carrying out slicing the transmission spectrum, non-transmission during elementary non-transmission segments and measuring parameters.

3. The method as claimed in claim 1, wherein said system comprises a plurality of groups of transmission equipment items, the slicing, non-transmission and measuring being carried out in a coordinated manner for the whole group.

4. The method as claimed in claim 1, wherein said system comprises a plurality of groups of transmission equipment items and in that, a single slicing is carried out for at least one group, so that none of the equipment items of this group transmits during the elementary non-transmission segments.

5. The method as claimed in claim 1, wherein characteristics of frequency and/or of duration of the elementary segments are determined as a function of characteristics of the operating environment.

6. The method as claimed in claim 1, wherein said elementary non-transmission segments are distributed in time over a determined period and in frequency over the whole of the transmission spectrum to form a non-transmission pattern.

7. The method as claimed in claim 6, wherein said elementary non-transmission segments are distributed so as to form the non-transmission pattern as a function of characteristics of the operating environment.

8. The method as claimed in claim 6, wherein the slicing as well as the non-transmission and measuring steps are repeated several times for one and the same transmission spectrum, so as to form several non-transmission patterns, the slicing comprising the inter-combining of the various patterns.

9. The method as claimed in claim 1, wherein at least two measuring on distinct elementary non-transmission segments are carried out simultaneously.

10. The method as claimed in claim 9, wherein said non-transmission and measuring on an elementary segment are repeated without allocating any non-transmission segment in segments reserved for particular equipment items.

11. A method for allocating the spectrum of a multicarrier signal of a communication system, wherein the method comprises the measurement of the occupancy of the spectrum according to the method of any one of claims 1 to 10 as well as a allocating the spectrum between transmission equipment items of the system as a function of said measurements.

12. A computer program medium for an equipment item of a multicarrier radiofrequency signal communication system, wherein the program comprises instructions which, when they are executed on a computer of this equipment item, control the implementation of the method according to at least any one of claims 1 to 10.

13. An equipment item for a multicarrier radiofrequency signal communication system, wherein this equipment item comprises means for slicing at least one transmission spectrum into subsets of carriers and for time slicing within the subsets to form elementary time/frequency segments and means for signal non-transmission during elementary non-transmission segments mutually shifted over time and in frequency.

14. An equipment item for a multicarrier radiofrequency signal communication system, wherein this equipment item comprises means for receiving a signal comprising elementary time/frequency non-transmission segments during which no signal is transmitted by at least one equipment item of the system and means for measuring chosen parameters of signals conveyed in the transmission spectrum during each of these elementary non-transmission segments.

15. A multicarrier radiofrequency signal comprising elementary data segments corresponding to time periods determined over determined subsets of carriers, wherein it comprises elementary non-transmission segments mutually shifted over time and in frequency which do not comprise any data.

16. The radiofrequency signal as claimed in claim 15, further comprising signalling information cues representative of the shifts between the non-transmission segments.
